(19) United States
(12) Patent Application Publication
(10) Pub. No.: US 2010/0318436 A1
(43) Pub. Date: Dec. 16, 2010

(54) INCENTIVE COMPATIBLE SELECTION MECHANISM

(75) Inventors: Kamal Jain, Bellevue, WA (US); Niv Buchbinder, Cambridge, MA (US); Mohit Singh, Cambridge, MA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/484,254

(22) Filed: Jun. 15, 2009

(51) Int. Cl. G06Q 30/00; G06N 5/02; G06F 17/30

(52) U.S. Cl. 705/26; 706/52; 705/10; 707/759; 707/713

(57) ABSTRACT

A system that selects items from a plurality of items is described herein. The system includes a receiver component that receives a plurality items for an activity in a sequence having an order. A selection component sequentially evaluates each of the items in the sequence in the order received by the receiver component and for each item being evaluated determines that an evaluated item is to be uniquely selected out of the plurality of items immediately upon evaluation thereof. The selection component selects the item such that when the value of the item is higher than the values of all previous items in the sequence, any position in the sequence has a substantially similar probability as any other position to have the item selected.

### BACKGROUND

Various activities such as job interviews and on-line auctions often include an opportunity for individuals participating in the activity to enhance their chances of achieving a positive outcome (e.g. being offered a job, winning the auction, etc.) in a manner that decreases the efficiency of the activity.

For example, in an employment setting in which an employer interviews a large pool of candidates, some candidates may choose to delay their arrival time for an interview so that their particular interview does not occur at the beginning of the interview process in order to increase their probabilities of being hired. Such practices may decrease the efficiency of the hiring process by compressing a higher distribution of candidate interviews into a shorter amount of time at the end of the interview process. As a result, the probability of hiring the best candidates may be lower than if the candidates were interviewed in a more random and evenly distributed manner.

Also, for example, in an on-line auction mechanism in which sellers of resources (e.g. airline tickets, hotels, car rentals, etc.) accept bids provided by individuals and immediately determine whether to accept the bid for the resource, some individuals may choose to delay their bids until closer to the expiration of the desired resource (e.g. the dates of the desired travel or rental reservation) in order to try to achieve higher utility from the auction. In an auction environment for example, a bidder's utility may correspond to the difference between their true value for the resource and the wining price for the resource. However, such practices of delaying the submission of bids may decrease the efficiency of the auction and associated servers carrying out the auction as well as lower the opportunity for relatively higher bids to win the resource.

### SUMMARY

The following is a brief summary of subject matter that is described in greater detail herein. This summary is not intended to be limiting as to the scope of the claims.

Described herein are various technologies relating to systems which provide incentive mechanisms capable of producing more efficient activates related to selecting an item (such as winning bid in an auction or an candidate for a job position) from a group of items having different relative values and being evaluated for selection at different times. When auctions are considered, the ability to maximize the probability of selecting the bid with the highest amount may be achieved by providing an incentive that encourages all bidders to bid what they believe to be the true value of the resource and to discourage bidders from delaying their bid in order to attempt to win the auction with higher utility.

For example, an auction format may allow a plurality of bidders to provide a single irrevocable bid during the auction for a single resource such as an airline ticket, hotel room, car rental or other resource (without know the bid amounts of other bidders), and be immediately informed if their bid has won and the resulting price for the resource. If the resource will expire (such as a ticket, hotel room or other reservation with fixed dates of travel or use), the seller of the resource typically prefers the bidders to make their bid for the resource as soon as possible after they decide there is a need for the resource. Bidders delaying the submission of their bid is an undesirable property, since airlines, hotels and other sellers of resources would like to plan ahead with respect to capacity. In addition, manipulating arrival times may lead to undesirable consequences, including congestion on the auction server in cases where many bidders submit bids simultaneously or in a short period of time.

To encourage the bidders to bid early and with relatively higher bid amounts, an example system may carry out the auction through an on-line web site or other computer based environment, with rules that give each bidder a non-zero probability of winning the bid (given a sufficiently high bid amount), in which any position in the sequence of submitted bids has the same (or substantially similar) probability of being selected as the winning bid for the auction. In addition, the system may carry out the auction with rules that enable bidders to have a higher probability of receiving a lower purchase price by bidding as early as possible during the action with a relatively high bid amount. For example, rather than basing the price of the resource on the amount of the winning bid, the price for the resource may correspond to the highest bid of previously submitted non-winning bids, which will typically be less than the winning bid amount.

When each bid is received, the system may employ a selection component that evaluates each bid in the order of the sequence it is received to determine if the bid has the highest amount bid so far received for the auction. If the bid does not have the highest bid amount received so far, the bid is rejected and the next received bid is evaluated. However, if the bid amount is the highest bid so far, the selection component will determine whether to select the bid with a selection probability based on the position of the bid received in the sequence of bids received and the number of bids expected to be received for the auction. For example, a bid amount may be accorded a selection probability of 1% of being selected. In this case, even though the bid may have the highest bid amount evaluated so far, there is a 99% chance that the system will not select the bid, and will instead move on to the next bid in the sequence to evaluate.

Furthermore, the selection component can select the item such that when the value of the item is higher than the values of all previous items in the sequence, any position in the sequence has the same or a substantially similar probability as any other position to have the item selected. Thus, in a hypothetical example, given a random distribution of bid amounts and a known number of total bids, before the auction starts the winning bid has an equal probability of being selected at any of the positions in the sequence of bids capable of being received during the auction.

With these rules, potential bidders receive more utility out of the auction (e.g. a higher difference between their true value for the resource and the winning price for the resource) by bidding earlier and minimizing the probability of higher bid amounts being submitted previously by non-winning bidders. Further, because the odds of winning the bid (given a suitably high bid amount) are substantially similar regardless of when the bid is submitted in the sequence of submitted bids, the system does not reward bidders for delaying their bids.

Other aspects will be appreciated upon reading and understanding the attached figures and description.

### BRIEF DESCRIPTION OF THE DRAWINGS

FIG. 1 is a functional block diagram of an example system that facilitates selecting an item for an activity.

FIG. 2 is a functional block diagram of an example system having a selection component that has different performance characteristics which are configurable.

FIG. 3 is a functional block diagram of an example system that facilitates selecting bids in an online auction.

FIG. 4 is a functional block diagram of an example system that facilitates selecting bids in an online auction by estimating a total number of expected bids for the auction.

FIG. 5 is flow diagram that illustrates an example methodology for selecting an item.

FIG. 6 is flow diagram that illustrates an example methodology for selecting bids in an online auction.

FIG. 7 is an example computing system.

### DETAILED DESCRIPTION

Various technologies pertaining to selecting items with an incentive compatible selection mechanism will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

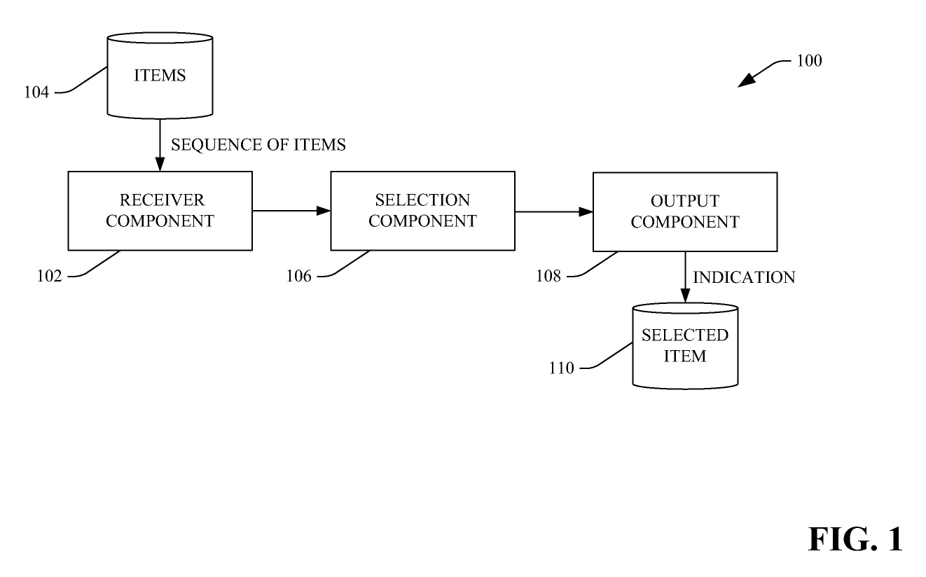

With reference to FIG. 1, an example system 100 that facilitates selecting an item from among a plurality of items is illustrated. For example, the system 100 may be used in an auction environment, where the items correspond to a plurality of bids. In another example, the system 100 may be used in an employment setting, where the items correspond to candidates for an employment position. In further examples, the system may be used for other activities in which an item is to be selected from a plurality of items.

The system 100 includes a receiver component 102 that receives a plurality items for an activity from a data repository 104. For instance, the data repository 104 may be or include a memory, data base, hard drive, or any other data store in a computing device from which items may be received by the receiver component 102. Furthermore, the data repository 104 may store all of the items or a subset of the items at one time. For example, in an employment setting, the data repository may correspond to a database with a complete set of items (e.g. data representative of candidates) stored therein prior to the receiver component receiving an item. Also for example, in an auction, the data repository may correspond to a buffer in a web server, that stores items (e.g., bids) received intermittently from a plurality of other source (e.g. bidders connected to the web server via the Internet) until the receiver component 102 is ready to process the items.

The receiver component 102 receives the items in a sequence having an order. For example, with an activity such as an auction where items such as bids are intermittently received over time, the order of the sequence may correspond to the order that bids are received by a web server. However, in other activities, such as an employment setting, (where items correspond to candidates), the order of the sequence may correspond to the order candidates are interviewed (for which appointments may be set randomly and/or at the discretion of the candidates).

Items received by the receiver component 102 may include data that uniquely identifies each item from each other item such as a unique identification number, key, name, or any other data which can be used to distinguish one item from another. In addition, each item has a value assigned thereto. The values for different items may not be unique, such that two or more items may have the same value. In an auction, the value may correspond to a monetary amount of a bid. However, in other activities, the value assigned to an item may correspond to any other property that can be used to determine which of two or more items has a highest relative value. For example, in an employment setting, the value assigned to a candidate may correspond to a relative performance of the candidate during an interview and/or other quantifiable qualifications for an open employment position.

In addition, items may include or be associated with other data accessible by the system, such as the name and address of the bidder in an auction, a credit card to charge a purchase price for a winning bid, or any other data that may be needed or useful in carrying out the activity for which an item is selected.

The system 100 may additionally include a selection component 106 that sequentially evaluates each of the items in the sequence in the order received by the receiver component 102. For each item being evaluated, the selection component 106 can determine whether an evaluated item is to be uniquely selected out of the plurality of items immediately upon evaluation thereof. Once an item is selected by the selection component 102, no other items can be selected for the particular activity for which the selection was made. For example, with an auction, each bid received by the receiver component is evaluated in the order received until a bid is selected to win the particular resource being auctioned of (e.g. airline tickets, hotel booking, etc.). Once a bidder is selected, even though there may be addition time left to evaluate bidders, no further bids can be selected to win the auction.

The system 100 may also include an output component 108. The output component 108 may cause an indication of the item selected by the selection component 106 to be stored in a data repository 110, which can be a memory, database, hard drive, or any other data store in which an indication of the item that has been selected may be stored for later retrieval and use by the system. For example, the data indicative of the selected item may be stored in a memory from which the data is retrieved and displayed through operation of a display device.

With more detail pertaining to the selection component 106, such component 106 can determine to select an item being evaluated based at least in part upon the value assigned to the item compared to values of other items previously evaluated by the selection component, a position of the item in the sequence of received items, and a total number of items expected to be received for the activity. In addition, the selection component 106 can be configured to select an item such that when the value of the item is higher than the values of all previous items in the sequence, any position in the sequence has the same (or substantially similar) probability as any other position to have the item selected. Therefore, users submitting items (e.g. bids in an auction) can perceive that if the items were received in random order, then any bid would have an equal chance of being selected. In addition, users would also perceive that submitting items such as bids earlier in the sequence of items submitted will increase the probability of receiving a lower price (if the bid was selected). As used herein, the system 100 can be referred to as incentive compatible when configured as described above.

In addition, although the described example system 100 may be incentive compatible (and/or substantially incentive compatible), it is to be understood that the selection component 106 may be configured differently such as to carry out one or more of the features described herein for selecting an item in a manner that may not be substantially incentive compatible (e.g. prior to the start of the auction, one or more positions in the sequence of received items may have an automatically assigned zero probability of being selected).

For instance, when an item is being evaluated, the selection component may employ a mechanism that selects an item based on a probability of selecting the item corresponding to a selection probability αᵢ calculated as follows:

$${α}_{i} = \frac{i}{2 τ n - i + 1} \qquad ( 1 )$$

where 1≦i·≦τn and the value of the item is the highest value compared to the values of the previously evaluated (and not selected) items in the sequence, i is the position of the item in the sequence, and 0≦τ≦1.

The value of τ may be selected based on the characteristics desired for the system 100 which are described in more detail below. In addition, the selection component 106 may be configured such that when τn<i·≦n, and the value of the item is the highest value compared to the values of the previously evaluated items in the sequence, the selection component 106 always selects the item (e.g. the calculated selection probability corresponds to a value of 1).

Furthermore, the selection component 106 may use a calculated selection probability to select an item by determining a random number between 0 and 1 for each item being evaluated. The selection component 106 may then select the item when the determined random number is less than or equal to the calculated selection probability for the item. However, it is to be understood that the selection component 106 may use other statistical techniques for selecting an item with a probability corresponding to a selection probability calculated for the item.

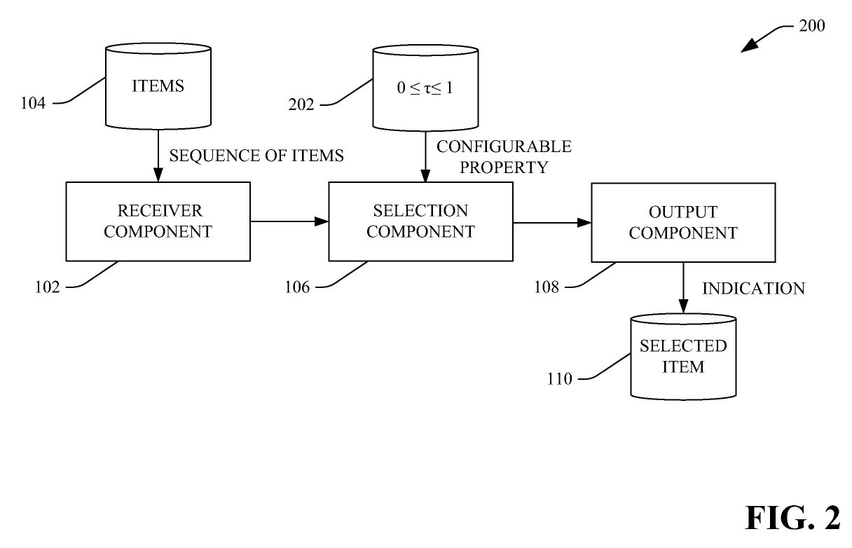

Referring now to FIG. 2, an example system 200 that facilitates selecting an item is illustrated, wherein the selection component 106 is configured based upon configurable properties such as the value of τ (or any other properties) stored in at least one data repository 202.

The value of τ may be a number of different values which provide the system 200 with distinct characteristics. For example, the value of τ may be set to a value corresponding to

$$\frac{1}{\sqrt{e}}$$

(e.g. 0.606) to cause the system 200 to have the highest probability of selecting the item with the highest value from amongst all received items and items expected to be received. Also, for example, the value of τ may be set to a value of ¾ (e.g. 0.75) to cause the system 100 to have the highest probability of selecting the item with the highest value with the item and with the second highest value being evaluated earlier in the sequence.

In a further example, the selection component 106 may select an item based on a probability of selecting the item corresponding to a selection probability αᵢ calculated in a manner as follows:

$${α}_{i} = \frac{i}{2 τ n - i + 1} \qquad ( 2 )$$

where 1≦i·≦τn and the value of the item is the highest value compared to the values of the previously evaluated (and non-selected) items in the sequence, i is the position of the item in the sequence, and ½≦τ≦1.

However, if τn<i·≦n, then the selection component 106 may calculate a rank for the item based on the position of the item if placed in order by value with respect to all of the previously evaluated items. The selection component 106 may then determine a selection probability of the item that corresponds to:

αᵢ=r−└r┘, where the rank for the item is └r┘+1 (3)

or corresponds to:

αᵢ=1, where the rank for the item is in top └r┘. (4)

Here

$$r = \frac{i}{2 τ n - i + 1}$$

and may be calculated by the selection component 106. For items with a common value, the selection component 106 may randomly assign (or use another tiebreaking mechanism to assign) which item is assigned an earlier/later respective position in the ranks of the items.

By configuring the selection component 106 with a mechanism that carries out these described calculations and determinations, the value of τ may have additional values which provide the system 100 with a plurality of distinct characteristics. For example, the value of τ may be set to a value of ½ to place the selection component in a “must select” mode, in which the selection component 106 always selects the last item regardless of bid amount (e.g. position n in the sequence when a previous item has not yet been selected). In addition, the value of τ may be set to a value of 1 to prevent equations 3 and 4 from ever being used to determine the selection probability. As a result, the selection component 106 is placed in a “regret free” mode in which when it selects an item, the item selected always has the highest value of all items previously evaluated. However, in this mode the auction may end without selecting a bid.

In these examples, in the “must select” mode, the selection component 106 has a configuration before the auction begins in which each position (1 to n) in the sequence has a probability of having a winning bid corresponding to

$$\frac{1}{2 n} .$$

Also in the “regret free” mode, the selection component 106 can have a configuration before the auction begins in which each position (1 to n) in the sequence has a probability of having a winning bid corresponding to

$$\frac{1}{2 n} .$$

In addition to the above described equations, it is to be understood that the selection component 106 may use different equations with different configurable properties to achieve substantially incentive compatible systems. For example, different configurable properties and/or different equations may be used which generate selection probabilities in a different manner. Also, the selection component 106 may retrieve predetermined selection probabilities from a data repository rather than calculating them when an item is being evaluated.

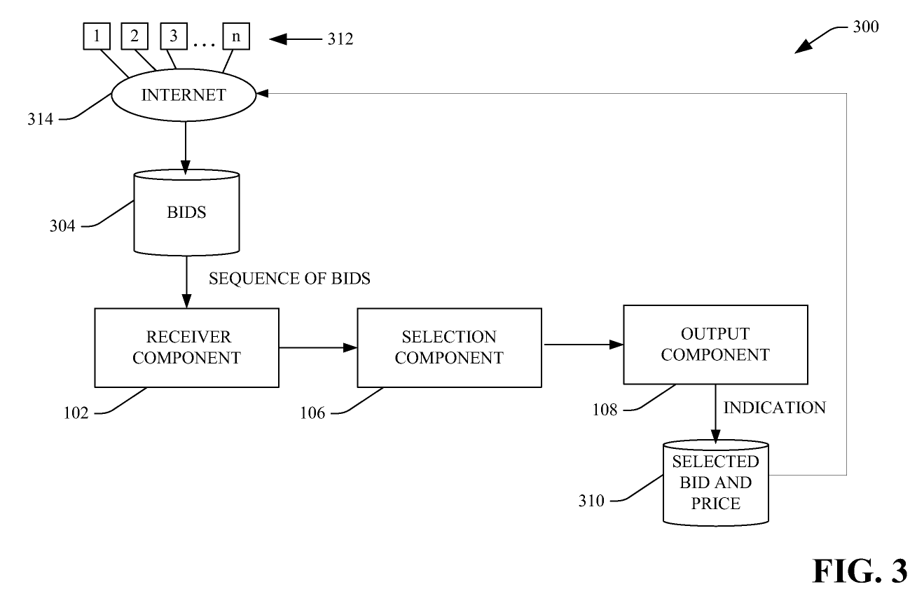

Referring now to FIG. 3, an example system 300 that facilitates selecting an item in the form of a bid for an on-line auction is illustrated. Here, the system 300 may includes the receiver component 102, wherein the receiver component 102 is configured to accept bids from a data repository 304 such as a memory of a web server or any other computing device capable of accepting data corresponding to bids from a plurality of users. In this example, the system 300 may conduct an auction in which bids are received from a plurality of client devices 312 connected to the system through a network such as the Internet 314. Such client devices 312 may include PCs, mobile phones, PDAs, or any other computing device capable of submitting bids by a user to the system 300.

The system may carry out the auction over a predetermined timeframe with a fixed beginning time and a fixed end time. For example, a resource being auctioned off may include an end time that is derived from a critical date of the resource (e.g. a seat on an airline with a specified departure date or a hotel reservation with a beginning day/night for staying in a room). In such cases, the end time for the auction may correspond to a critical date of the resource, or may correspond to a predetermined amount of time before the critical date (e.g. one day) to give the buyer a period of time to prepare for the use of the resource. The beginning time for the auction may be set to provide a reasonably large number of bidders for the item before the end time of the auction.

For an auction carried out by the system 300, bidders submitting bids may know the beginning and end times of the auction and may choose to submit their bids at any time within the beginning and end times. However, they may submit only one bid. In addition, bidders may only know the amount that they are submitting and not the amounts of previous bidders. Further, at the time a bid is submitted, the auction immediately notifies the bidder if the submitted bid is a winning bid along with the price for the resource that is won. The price of the won resource may be determined by the system to correspond to the highest amount of the bids previously submitted and not selected before the winning bid. In addition, prior to a bidder winning the auction (which causes the auction to end prior to the end time), each bid has a non-zero probability of being selected, and based on the mechanisms discussed previously may have a probability of being selected which is the same regardless of how early or late in the sequence of bids the item is submitted.

In some examples, the auction may accept bid amounts of any amount (e.g., 1 cent to 1 million dollars). However, in alternative embodiments, the auction may specify minimum (and optionally reasonable maximum) bid amounts that must be submitted as a bid in order to be eligible to be evaluated by the system. Also, the system 300 may carry out a determination as to whether a credit card or other account of the bidder is authorized to pay for the bid amount prior to making a bid eligible to be evaluated by the system.

Bids received by the receiver component 102 may include data associated with the bidder submitting the bid (e.g. a unique ID, name address, credit card information, etc.). In addition, the bid includes data representative of the monetary amount of the bid. Furthermore, since bids can be submitted between predetermined start and end times, the receiver component 102 may also be configured to assign each bid with its arrival time. An arrival time can be used by the receiver component 102 to place the bids in a sequence in order via their respective arrival times. The selection component 106 evaluates each item in the order of the sequence. For bids that arrive at the same time, the system 300 may randomly assign (or use another tiebreaking mechanism to assign) which bid is assigned an earlier/later respective position in the sequence.

For each bid being evaluated, the selection component 106 can make an irrevocable decision of whether to select the bid as the winning bid for the resource as discussed previously. If the item is selected, the output component 308 can cause an indication of the selected bid and its winning price to be stored in a data repository 310 such as the memory of a web server from which the user submitting the bid can immediately confirm that the bid was accepted. In addition, the output component 108 may cause an indication of the non-selected bids to be stored in the data repository 310 as well. The selection component 106 may calculate the winning price as discussed previously based on the highest amount of previously evaluated bids.

In an example implementation of the system 300, a web server comprising the system 300 may be configured such that a user submitting a bid through a web page immediately receives a return web page with an indication of whether the item was selected or not. For a winning bid, the system 300 may immediately extract a fee from the bidder via charging a credit card or other account associated with the bidder. Also, the indication returned to the bidder regarding the winning bid may provide additional information and functionality for enabling the winning bidder to use the resource (e.g. place winning tickets in the name of a particular traveler).

In order for the selection component 106 to determine selection probabilities for each evaluated item, the selection component 106 can determine the total number of bids that will be received during the beginning and end times for the auction. In some auctions, the system may predetermine a number of bids that are likely to be accepted during the auction by having bidders preregister their intent to submit a bid during the auction. However, in other auctions, the number of bids expected to be received during the auction may be estimated.

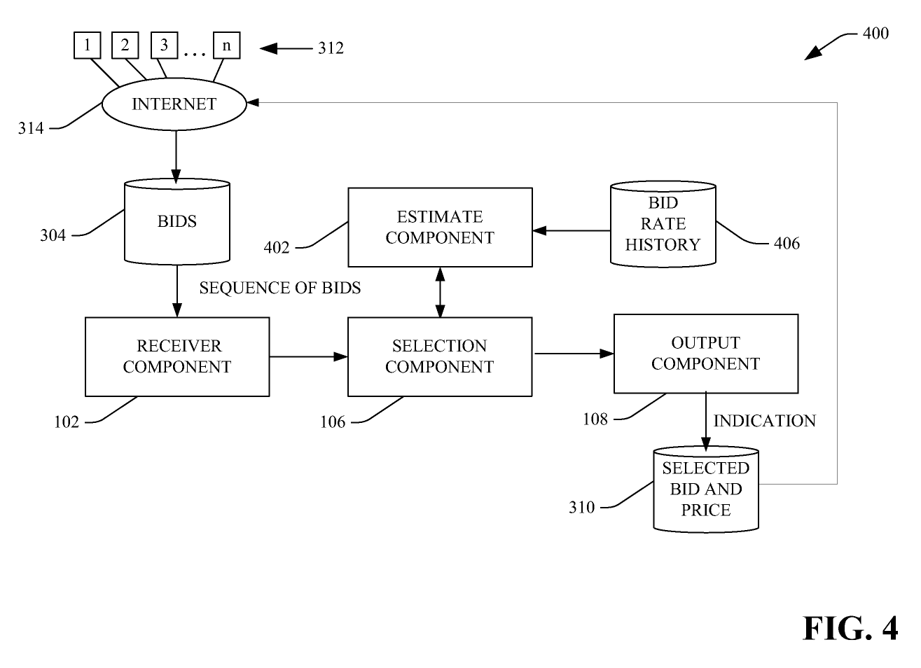

Referring now to FIG. 4, an example system 400 that facilitates selecting a bid for an on-line auction is illustrated. The system 400 includes an estimate component 402 that can calculate an estimation for the total number of bids expected to be received based on historical information stored in a data repository 406 regarding patterns of received bids for auctions. The estimate component 402 may base a determination of a total number of bids on bid history rates for similar resources, similar auction dates, or any other information that can be used to approximate a reasonable predication for the total number of expected bids to be received for an action to be carried out by the system 400. In this example, the selection component 106 may query the estimate component 402 with information regarding an auction (e.g. type of resource, beginning and end times) and receive in return an estimated number of bids for the auction. This estimated number of bids, for example may be used for the parameter n in the equations (1)-(4) discussed previously.

However, where expected bids is an estimate, there exists the possibility that when the end time occurs and the auction closes, the number of received bids (assuming the auction was not won early) may not correspond to the total number of bids n used by the selection component 106 to determine the selection probabilities for each bid. In such cases, the auction may (based on hindsight) not have corresponded to a mathematically exact incentive compatible auction with each position in the sequence of bids having the same probability of having a winning bid. Also, it should be noted that in cases where the actual number of bids is greater than the total expected number of bids n, bids after n, may have a zero probability of being selected. Thus as defined herein, the probability that each position in the sequence of bids is “substantially similar” with respect to having a winning bid selected, corresponds to each probability for each position being within 50% of the probabilities for each other position with respect to bids that are not after the expected number of bids n. Also, as defined herein, an auction is substantially incentive compatible when the probabilities of each position in the sequence of bids have substantially similar probabilities of having a winning bid.

In addition, it should be understood that auctions may base the determination of the selection probabilities on other equations or predetermined sets of selection probabilities which are substantially incentive compatible, but which do not correspond to the same values of selection probabilities for each position i of a sequence of bids determined from equations (1)-(4).

In another example, in order to increase the probability that the total estimated number of bids for the auction (e.g. n), corresponds to the actual number of bids, the estimate component 402 may select a value of n which has a high probability of being reached (assuming earlier bids have not won the auction) prior to the end time of the auction. Thus, the auction may end either when the estimated number of bids have been received and/or the end time has passed for the auction. In an example, the value of n may be posted on a web page for the auction prior to the beginning time of the auction.

In addition, in another example, the estimate component 402 may be used to update the value of n being used by the selection component 106 based on actual rates of received bids by the receiver component 102. Updating the value of n used by the selection component 106 in mid auction may result in different positions in the sequence of bids having different probabilities for having the winning bid. However, an updated value of n may be chosen which is still sufficiently close to the originally estimated value of n determined by the estimate component 402 so that the probabilities of any position in the sequence having the winning bid is still substantially similar.

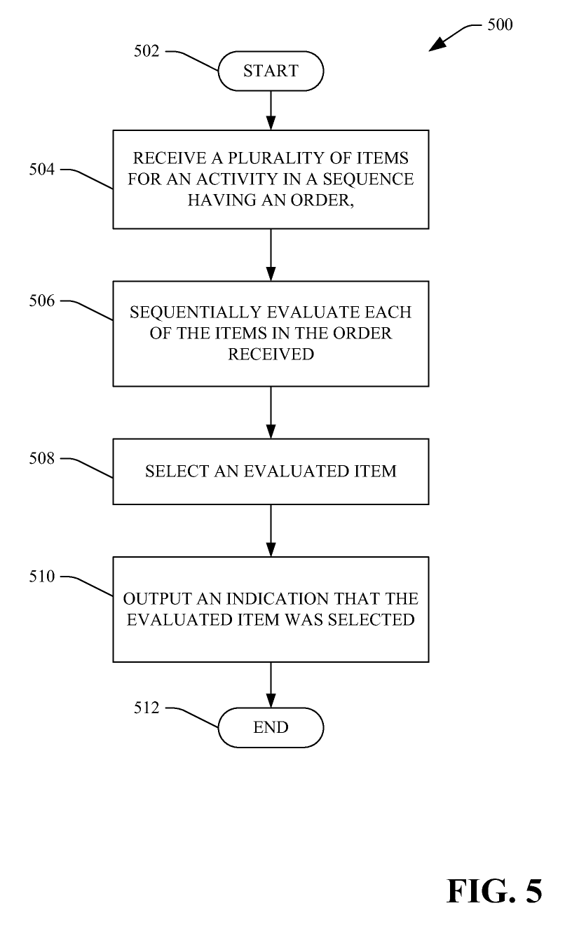

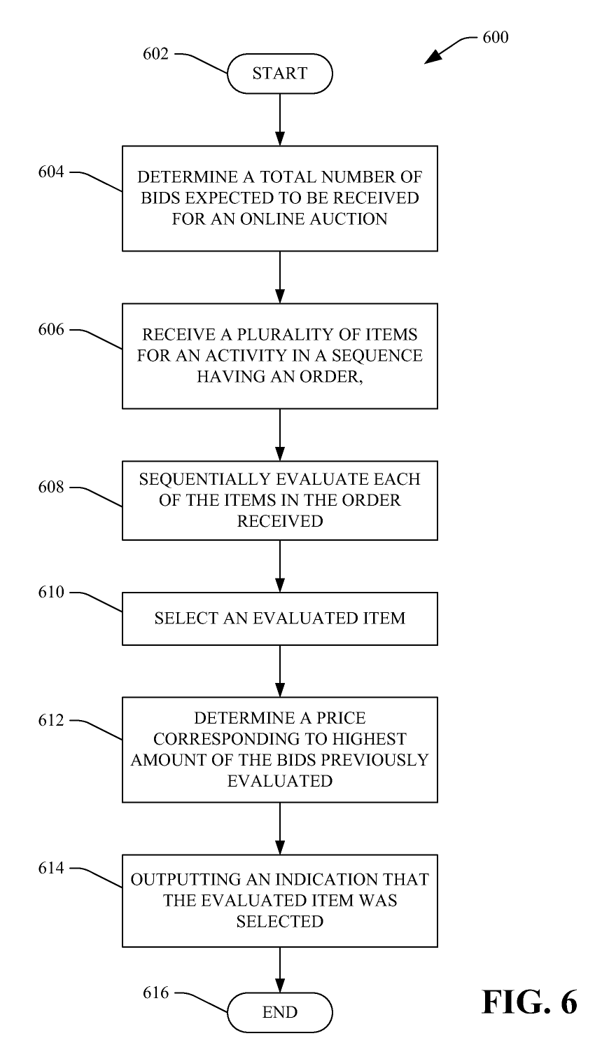

With reference now to FIGS. 5-6, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 5, a methodology 500 that facilitates selecting an item from a plurality of items for an activity is illustrated. The methodology 500 begins at 502, and at 504 a plurality of items for the activity in a sequence having an order are received. At 506, each of the items is sequentially evaluated in the order received in the sequence.

At 508, immediately upon evaluation of an item, the item is uniquely selected out of the plurality of items for the activity based at least in part upon the value assigned to the item compared to values of other items previously evaluated, a position of the item in the sequence, and a total number of items expected to be received for the activity. Additionally, the item can also be selected such that when the value of the item is higher than the values of all previous items in the sequence, any position in the sequence has a substantially similar probability as any other position to have the item selected. At 510, the methodology 500 outputs an indication to a data repository that the evaluated item was selected in for the activity. The methodology 500 ends at 512

Referring now to FIG. 6, a methodology 600 that facilitates selecting a bid from a plurality of bids in an auction is illustrated. The methodology 600 begins at 602, and at 604 a total number of bids expected to be received for an online auction for a resource based on a deadline (e.g. departure or use time) of the resource (e.g. airline ticket, a car rental, and a hotel booking) is determined. At 606, a plurality of bids for the auction are received from a data repository in a computing device, wherein the plurality of bids are received in a sequence having an order. Each bid may include an amount and data representative of a bidder. At 608, each bid is sequentially evaluated in the order received.

At 610, a bid out of the plurality of bids is uniquely selected immediately upon evaluation thereof, wherein selection is based at least in part upon the amount of the bid compared to amounts of other bids previously evaluated, a position of the bid in the sequence, and the total number of bids expected to be received for the auction. Further, the bid can be selected such that when the amount of the bid is higher than the amounts of all previous bids in the sequence, any position in the sequence has a substantially similar probability as any other position to have the bid selected. At 612, a price that corresponds to the highest amount of the bids evaluated in the sequence prior to the selected bid is determined. At 614, an indication of the price and at least a portion of the data representative of the bidder for the selected bid is output. The methodology 600 completes at 616.

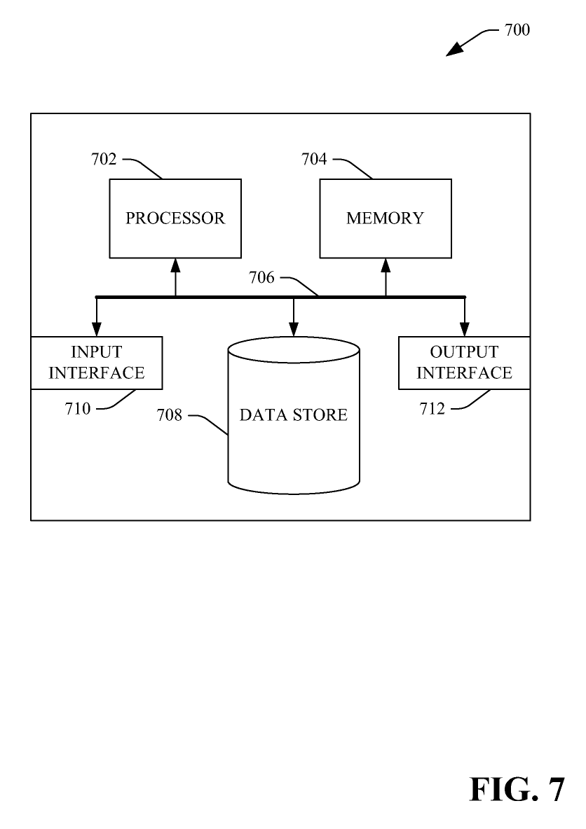

Now referring to FIG. 7, a high-level illustration of an example computing device 700 that can be used in accordance with the systems and methodologies disclosed herein is illustrated. For instance, the computing device 700 may be used in a system that supports selecting items (e.g. a bid) from a plurality of items (e.g. bids) for an activity (e.g. an auction). In another example, at least a portion of the computing device 700 may be used in a system that supports selecting items from a plurality of items for an activity. The computing device 700 includes at least one processor 702 that executes instructions that are stored in a memory 7004. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store data representative of items, configurable parameters used to select an item, and an indication of an item that was selected.

The computing device 700 additionally includes a data store 708 that is accessible by the processor 702 by way of the system bus 706. The data store 708 may include executable instructions, data representative of items, configurable parameters used to select an item, and an indication of an item that was selected, etc. The computing device 700 also includes an input interface 710 that allows external devices to communicate with the computing device 700. For instance, the input interface 710 may be used to receive instructions from an external computer device, corresponding to items to be evaluated for selection, parameters for configuring how to select items, etc. The computing device 700 also includes an output interface 712 that interfaces the computing device 700 with one or more external devices. For example, the computing device 700 may display text, images, etc. by way of the output interface 712 corresponding to the operation of the computing device, and indications of the item that was selected.

Additionally, while illustrated as a single system, it is to be understood that the computing device 700 may be a distributed system. Thus, for instance, several devices may be in communication by way of a network connection and may collectively perform tasks described as being performed by the computing device 700.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A system comprising the following computer-executable components:
a receiver component that receives a plurality items for an activity from a data repository in a computing device, wherein the items are received by the receiver component in a sequence having an order, wherein the items each have a value assigned thereto;
a selection component that sequentially evaluates each of the items in the sequence in the order received by the receiver component and, for each item being evaluated, determines that an evaluated item is to be uniquely selected out of the plurality of items immediately upon evaluation thereof based at least in part upon the value assigned to the item compared to values of other items previously evaluated by the selection component, a position of the item in the sequence, and a total number of items expected to be received for the activity, wherein the selection component selects the item such that when the value of the item is higher than the values of all previous items in the sequence any position in the sequence has a substantially similar probability as any other position to have the item selected; and
an output component that causes an indication of the item selected by the selection component to be stored in the data repository.

2. The system of claim 1, wherein the selection component selects the item based on a selection probability, wherein the selection probability is computed by way of the following:
$${α}_{i} = \frac{i}{2 τ n - i + 1}$$
where αᵢ is the selection probability, τ is a configurable parameter, i is the position of the item in the sequence, n is a number of items in the sequence, 1≦i·≦τn, and ½≦τ≦1, and wherein the value of the item is the highest value compared to the values of the previously evaluated items in the sequence.

3. The system of claim 1, wherein the selection component determines a rank for each item corresponding to the value of the item compared to the values of all other items previously evaluated in the sequence, wherein the selection component selects the item based on a selection probability, wherein the selection probability is computed by way of the following:
αᵢ=r−└r┘ if τn<i·≦n
where αᵢ is the selection probability, i is the position of the item in the sequence, τ is a configurable parameter, n is a total number of items in the sequence, the rank of the item is └r┘+1, and where
$$r = \frac{i}{2 τ n - i + 1} .$$

4. The system of claim 3, wherein the selection component always selects the item when τn<i·≦n and the value of the item is the highest value compared to the values of the previously evaluated items in the sequence.

5. The system of claim 1, wherein the selection component is configured to determine which item to select based upon at least one configurable property received from the data repository, wherein the at least one property specifies that the selection component selects the item as a function of the item having a value that is highest compared to values of items previously evaluated in the sequence for the activity.

6. The system of claim 1, wherein the selection component is configured to determine which item to select based on at least one configurable property received from the data repository, wherein the at least one property specifies that the selection component selects the item if the item is received in a position in the sequence that corresponds to the total number of items expected to be received in the sequence regardless of whether the item has a value lower than a value of at least one previously evaluated item in the sequence.

7. The system of claim 1, wherein the selection component is configured to determine which item to select based on at least one configurable property received from the data repository, wherein the at least one property includes a first value that maximizes the probability of the selection component selecting an item with the highest value for all of the items received during the activity includes a second value that maximizes the probability of selecting an item with the highest value for all of the items received during the activity with an item earlier in the sequence with respect to the selected item having a second highest value for all of the items received during the activity.

8. The system of claim 1, wherein the activity corresponds to an online auction for a resource, wherein each item corresponds to a bid that includes data representative of a bidder and data representative of an amount bid, wherein the value for each item corresponds to the amount of the bid, wherein the indication output by the output component indicates at least a portion of the data representative of the bidder for the selected bid.

9. The system of claim 8, wherein the indication caused by the output component indicates a price for the resource, wherein the price corresponds to the highest amount of the bids previously evaluated in the sequence.

10. The system according to claim 9, wherein the resource includes a reservation having a deadline for which the bid must be selected, further comprising an estimate component that estimates the total number of bids expected to be received for the auction based at least in part upon the deadline, wherein the estimate component stores the estimated total number of bids expected to be received for the activity in the data repository.

11. A method comprising the following computer-executable acts:
a) receiving from a data repository in a computing device a plurality of items for an activity in a sequence having an order, wherein the items each have a value assigned thereto;
b) sequentially evaluating each of the items in the order received in (a);
c) immediately upon evaluation of an item evaluated in (b), uniquely selecting the item out of the plurality of items for the activity based at least in part upon the value assigned to the item compared to values of other items previously evaluated in (b), a position of the item in the sequence, and a total number of items expected to be received for the activity, such that when the value of the item is higher than the values of all previous items in the sequence any position in the sequence has a substantially similar probability as any other position to have the item selected; and
d) outputting an indication in a data repository that the evaluated item was selected in (c) for the activity.

12. The method of claim 11, wherein (b) includes determining a selection probability for the item corresponding to:
$${α}_{i} = \frac{i}{2 τ n - i + 1} ,$$
where αᵢ is the selection probability, τ is a configurable parameter, i is the position of the item in the sequence, n is a number of items in the sequence, 1≦i·≦τn, and ½≦τ≦1, and wherein the value of the item is the highest value compared to the values of the previously evaluated items in the sequence, and wherein (c) includes selecting the item based upon a probability of selecting the item corresponding to the selection probability determined for the item in (b).

13. The method of claim 11, wherein (b) includes determining a rank for the item based on the value of the item compared to the values of all other items previously evaluated, wherein (b) includes determining the selection probability of for the item, corresponding to:
αᵢ=r−└r┘ if τn<i·≦n
where αᵢ is the selection probability, i is the position of the item in the sequence, τ is a configurable parameter, n is a total number of items in the sequence, and the rank of the item is └r┘+1, where
$$r = \frac{i}{2 τ n - i + 1} .$$

14. The method of claim 13, wherein (c) includes selecting the item based upon τn<i·≦n and the rank of the item is top └r┘.

15. The method of claim 11, wherein (c) includes selecting the item based in part upon a determination in (b) that the item has a value that is always highest compared to values of items previously evaluated in (b).

16. The method of claim 11, wherein (c) includes always selecting the item if the item is received in a position in the sequence that corresponds to the total number of items expected to be received in (a) for the activity regardless of whether the item has a value lower than a value of at least one previously evaluated item in (b).

17. The method of claim 11, wherein (c) includes selecting the item based upon a configurable property received from the data repository, wherein the configurable property is configurable with a first value that maximizes the probability of the selection component selecting an item with the highest value for all of the items received during the activity, and is configurable with a second value that maximizes the probability of selecting an item with the highest value for all of the items received during the activity with an item earlier in the sequence with respect to the selected item having a second highest value for all of the items received during the activity.

18. The method of claim 11, wherein in (a) the activity corresponds to an online auction for a resource, wherein each item corresponds to a bid that includes data representative of a bidder and data representative of an amount, wherein the value for each item corresponds to the amount of the bid, wherein prior to (d) further comprising:
f) determining a price that corresponds to the highest amount of the bids evaluated in (b) in the sequence prior to the bid selected in (c), wherein in (d) the indication includes the price and at least a portion of the data representative of the bidder for the bid selected in (c).

19. The method of claim 18, wherein in (a) the resource includes a reservation having a deadline for which the bid must be selected, wherein prior to (b) further comprising:
g) estimating the total number of bids expected to be received for the auction based upon the deadline; and
h) storing the estimated total number of bids expected to be received for the auction in the data repository.

20. A computer-readable medium comprising instructions that, when executed by a processor, cause the processor to perform the following acts:
a) determining a total number of bids expected to be received for an online auction for a resource based on a deadline associated with the resource;
b) receiving from a data repository in a computing device, a plurality of bids for the auction in a sequence having an order, wherein the bids include an amount and data representative of a bidder;
c) sequentially evaluating each of the bids in the order received in (b);
d) immediately upon evaluation of a bid, uniquely selecting the bid out of the plurality of bids for the auction based at least in part upon the amount of the bid compared to amounts of other bids previously evaluated in (c), a position of the bid in the sequence, and the total number of bids expected to be received for the auction, such that when the amount of the bid is higher than the amounts of all previous bids in the sequence, any position in the sequence has a substantially similar probability as any other position to have the bid selected;
e) determining a price that corresponds to the highest amount of the bids evaluated in (c) in the sequence prior to the bid selected in (d); and
f) outputting an indication of the price and at least a portion of the data representative of the bidder for the bid selected in (d).
